(19) United States
(12) Patent Application Publication
(10) Pub. No.: US 2015/0365299 A1
(43) Pub. Date: Dec. 17, 2015

(54) LUCIDITY IN NETWORK MAPPING WITH MANY CONNECTIONS

(71) Applicants: Hans-Peter Schaerges, Mannheim (DE); Heinz Willumeit, St. Leon-Rot (DE)

(72) Inventors: Hans-Peter Schaerges, Mannheim (DE); Heinz Willumeit, St. Leon-Rot (DE)

(21) Appl. No.: 14/305,239

(22) Filed: Jun. 16, 2014

(51) Int. Cl. H04L 12/24; G06F 3/0484

(52) U.S. Cl. CPC H04L 41/22; G06F 3/04847; G06F 3/04842

(57) ABSTRACT

The present disclosure describes methods, systems, and computer program products for providing improved lucidity in network mapping with many connections. One computer-implemented method includes determining a connection type and initial visual settings for a connection associated with a graphical mapping, for the connection type: define one or more visual appearance functions to change the connection's visual appearance based upon the configuration of an adjustment mechanism and define a Z-order function to determine the Z-order of the connection type in relation to other connection types, determining that the adjustment mechanism configuration has been changed, and adjusting the connection, by operation of a computer, according to a value of the one or more visual appearance functions based on a value of the adjustment mechanism configuration.

### BACKGROUND

In software applications with network-type graphical mappings (e.g., lines) between/connecting elements that can be displayed on a graphical user interface, for example, mappings of database elements, business/process models, enterprise resource planning (ERP) scenarios/models, and the like, a large number of mappings can cause user confusion (e.g., due to visual “clutter”) and reduce the usefulness of the display. This issue becomes especially acute when a display is too small to represent an entire set of mapped elements on a single display and the visual display must be scrolled horizontally and/or vertically to bring elements and/or mappings into view on the display. A confusing and visually cluttered display can result in user dissatisfaction, a poor user experience, mapping and analysis errors, and/or rejection of the application in favor of a competing product.

### SUMMARY

The present disclosure relates to computer-implemented methods, computer-readable media, and computer systems for providing improved lucidity in network mapping with many connections. One computer-implemented method includes determining a connection type and initial visual settings for a connection associated with a graphical mapping, for the connection type: define one or more visual appearance functions to change the connection's visual appearance based upon the configuration of an adjustment mechanism and define a Z-order function to determine the Z-order of the connection type in relation to other connection types, determining that the adjustment mechanism configuration has been changed, and adjusting the connection, by operation of a computer, according to a value of the one or more visual appearance functions based on a value of the adjustment mechanism configuration.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the connection type can be one of a fully visible connection type where the endpoints of a connection are displayed on the same visual display or a partially visible connection type where one of the endpoints of a connection is not displayed on the same visual display as the other endpoint of the connection.

A second aspect, combinable with any of the previous aspects, wherein the one or more visual appearance functions and the Z-order function are continuous functions.

A third aspect, combinable with any of the previous aspects, wherein the one or more visual appearance functions include functions for width, dash, and space.

A fourth aspect, combinable with any of the previous aspects, wherein data associated with the connection type used by the one or more visual appearance functions comprises a tuple of visual appearance values, each visual appearance value associated with each configuration value of the adjustment mechanism.

A fifth aspect, combinable with any of the previous aspects, wherein the adjustment mechanism is a graphical user interface element with a discrete number of anchor points, each anchor point representing a configuration value of the adjustment mechanism.

A sixth aspect, combinable with any of the previous aspects, comprising adjusting, by operation of a computer, the Z-order of the connection of the connection type using the Z-order function.

The subject matter described in this specification can be implemented in particular implementations so as to realize one or more of the following advantages. First, the use of an application with graphical mappings can be visually de-cluttered using one or simpler graphical user interface (GUI) elements. Second, the method of visual de-cluttering is configurable (e.g., by an administrator). For example, in a first particular application, the use of different line styles, thickness, etc. can be configured to change with different GUI element settings; while in a second particular application, line color and brightness can be configured to change with the different GUI element settings. In this way, applications can be configured in a manner that is most advantageous to the particular application. Third, smaller displays can be used to perform, for example, development and analysis functions with respect to graphical mappings. This help to permit wider performance of these functions by users with mobile devices such as smart phones and tablet computers. Fourth, user confusion is reduced with working with graphical mapping applications (e.g., during development and analysis). Fifth, user dissatisfaction is reduced and user experience is enhanced; making it more likely that the graphical mapping application incorporating the GUI element functionality to provide improved lucidity in network mapping with many connections will be adopted by a wider user base. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system (EDCS) for providing improved lucidity in network mapping with many connections according to an implementation.

FIG. 2 illustrates a graphical network mapping with many connections according to an implementation.

FIG. 3 is a flow chart illustrating a method for providing improved lucidity in network mapping with many connections according to an implementation.

FIG. 4 is an example screenshot of a graphical network mapping displaying everything according to an implementation.

FIG. 5 is an example screenshot of a graphical network mapping adjusted to display certain types of connections less-prominently according to an implementation.

FIG. 6 is an example screenshot of a graphical network mapping further adjusted to display certain types of connections less-prominently according to an implementation.

FIG. 7 is an example screenshot of a graphical network mapping set to display a focus on selected mappings according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

This disclosure generally describes computer-implemented methods, computer-program products, and systems for providing improved lucidity in network mapping with many connections. Although the following description is focused on a database/model-type mapping, the described computer-implemented methods, computer-program products, and systems are also applicable to other uses of the described subject matter to assist in increasing lucidity in network-type mapping. For example, the described subject matter could be used in an aural-type capacity to help increase/decrease auditory awareness of aural connections between mapped auditory elements (e.g., voices, sounds, etc.). As will be appreciated by those of ordinary skill in the art, other uses of the described functionality consistent with this disclosure are certainly possible and are considered to be within the scope of the this disclosure.

In software applications with network-type graphical mappings (e.g., lines) between/connecting elements that can be displayed on a graphical user interface (GUI), for example, mappings of database elements, business/process models, enterprise resource planning (ERP) scenarios/models, and the like, a large number of mappings can cause user confusion (e.g., due to visual “clutter”) and reduce the usefulness of the display. This issue becomes especially acute when a display is too small to represent an entire set of mapped elements on a single display and the visual display must be scrolled horizontally and/or vertically to bring elements and/or mappings into view on the display. A confusing and visually cluttered display can result in user dissatisfaction, a poor user experience, mapping and analysis errors, and/or rejection of the application in favor of a competing product.

At a high level, a solution is to bundle connections according to different meaningful “types” and to give each type variable visualization parameters that can be controlled by, for example, a GUI element such as a slider. For the purposes of this disclosure, a slider can also be called a “dimmer.” In typical implementations, the variable visualization parameters will be different for each type. For example, connections from a selected node (e.g., represented by a particular GUI element) to other nodes on a visual display can be treated differently from connections from a non-selected node to other nodes on the visual display.

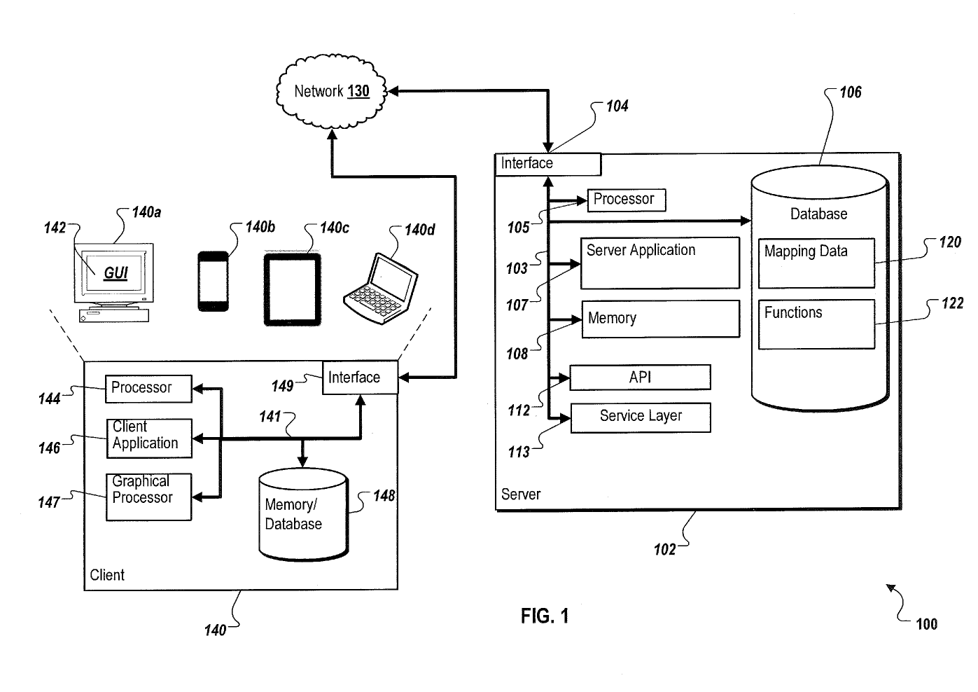

FIG. 1 is a block diagram illustrating an example distributed computing system (EDCS) 100 for providing improved lucidity in network mapping with many connections according to an implementation. The illustrated EDCS 100 includes or is communicably coupled with a server 102 and a client 140 that communicate across a network 130. In some implementations, one or more components of the EDCS 100 may be configured to operate within a cloud-computing-based environment.

At a high level, the server 102 is an electronic computing device operable to receive, transmit, process, store, or manage data and information associated with the EDCS 100. In general, the server 102 provides functionality appropriate to a server, including database functionality and receiving/serving content and/or functionality from/to a client permitting, for example, modeling operations as described herein. According to some implementations, the server 102 may also include or be communicably coupled with an e-mail server, a web server, a caching server, a streaming data server, a business intelligence (BI) server, and/or other server.

The server 102 is responsible for receiving, among other things, requests and content from one or more client applications 146 and/or graphical processors 147 associated with the client 140 of the EDCS 100 and responding to the received requests. In some implementations, the server 102 processes the requests at least in a server application 107 and/or database 106. In addition to requests received from the client 140, requests may also be sent to the server 102 from internal users, external or third-parties, other automated applications, as well as any other appropriate entities, individuals, systems, or computers. In some implementations, various requests can be sent directly to server 102 from a user accessing server 102 directly (e.g., from a server command console or by other appropriate access method).

Each of the components of the server 102 can communicate using a system bus 103. In some implementations, any and/or all the components of the server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the database 106, the server application 107, and/or wholly or partially in other components of server 102 (whether or not illustrated).

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required for providing improved lucidity in network mapping with many connections.

The server 102 also includes a database 106 that holds data for the server 102, client 140, and/or other components of the EDCS 100. Although illustrated as a single database 106 in FIG. 1, two or more databases may be used according to particular needs, desires, or particular implementations of the EDCS 100. While database 106 is illustrated as an integral component of the server 102, in alternative implementations, database 106 can be external to the server 102 and/or the EDCS 100. In some implementations, database 106 can be configured to store one or more instances of mapping data 120, functions 122, and/or other appropriate data (e.g., user profiles, objects and content, client data, etc. —whether or not illustrated).

The mapping data 120 can be any data, including data representing objects (e.g., elements, fields, etc.) to map, connections (described below), metadata, tuples (describe below), and other data used to generate models of network mappings with many connections. For example, the mapping data 120 can contain data to generate a model of a database schema in a database development application that can be used by a database designer to analyze, design, maintain, etc. an associated database. The mapping data can include, among other things, how data is to be mapped, layout position, visual display orientation and position (for mappings that stretch across multiple visual display screens and must be scrolled), zoom value, colors, text fonts, etc. The mapping data 120 can also include any data necessary to administer the mapping data 120, particular models, and systems and/or functions associated with the mapping data 120. For example, the mapping data 120 can contain security information related to user profiles, roles, access permissions, etc. to allow particular users to administer, for example, the mapping data 120, function 122, server application 107 (or other component of server 102), the client application 146/graphical processor 147 (or other component of the client 140), and/or other component of the EDCS 100.

The functions 122 include, in some implementations, continuous functions. Continuous functions are those in which small changes in input result in small changes on the output, otherwise the function is considered discontinuous. For example, a function describing the height h(t) of a child growing over time t is continuous. In contrast the sign function s(r) that maps each positive number to “+1”, each negative number to “−1,” and zero to “0” is discontinuous for the range value “0.” In the case of functions 122, a small change, for example in a graphical user interface (GUI) element (e.g., a GUI “slider”) setting can cause, among other things a small change in the visual characteristics of a connection in a graphical mapping, etc.

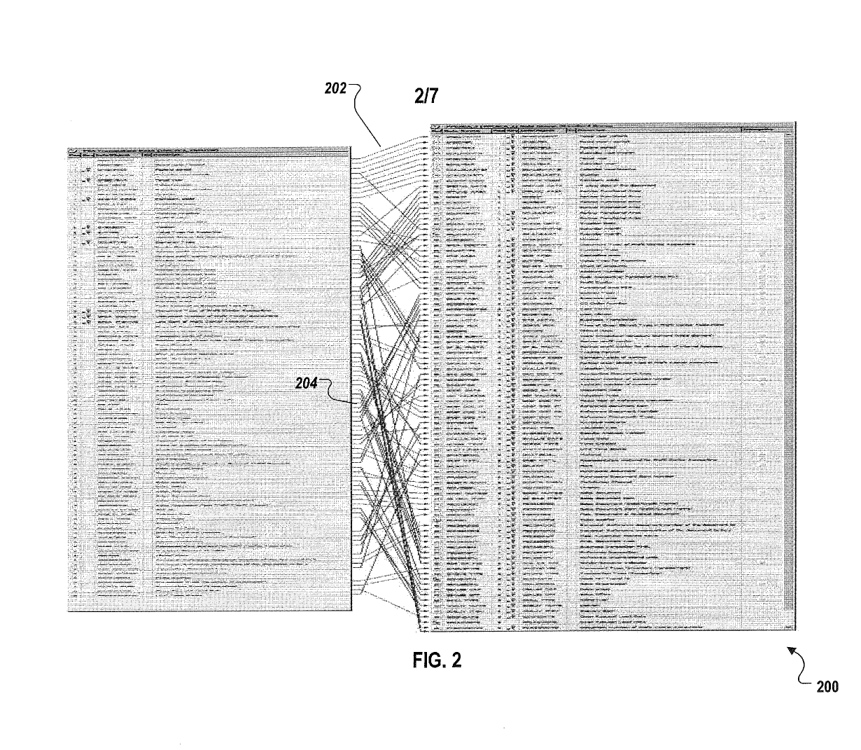

FIG. 2 illustrates a graphical network mapping 200 with many connections according to an implementation. As can be seen in FIG. 2, the connections 202 between fields of the displayed graphical elements can be confusing to a user analyzing the network mapping in that there are multiple connections “painted” on a visual display all in a similar style (e.g., appearing to overlap in places (e.g., at 204).

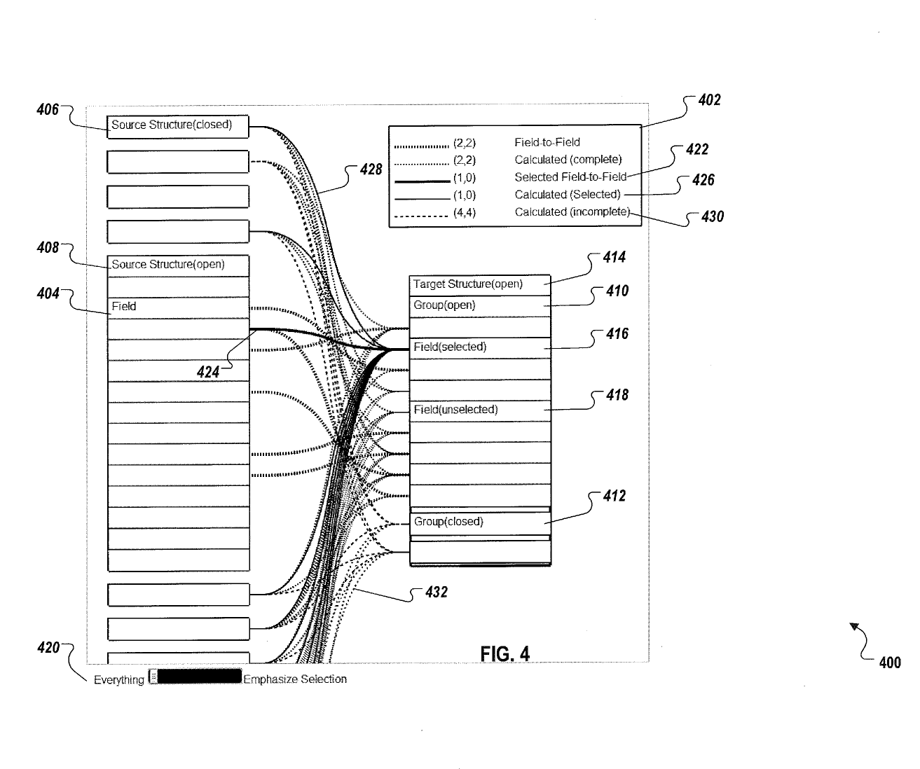

Returning to FIG. 1, connections, as defined in the mapping data 120, can be of different types (e.g., connection types (CTs)). For example, a connection from a field to a field (field-to-field connection), calculated complete, selected field-to-field, a closed structure-to-field, closed structure-to-closed group, and/or other connections (e.g., see FIG. 4, ref. 402). Whether a field/element of a network mapping is selected can also affect the visual appearance of connections associated with the selected network mapping as compared to the connections associated with the same field/element when unselected. Connections can be defined with a default initial color/appearance state (e.g., green and with a coarse dashed appearance, red with a solid thick line, and blue with a fine dotted line, etc.). In some implementations, the default initial color/appearance state can depend on an initial slider setting.

The visual appearance of connections belonging to a certain type of connection can be changed based on the above-described slider settings (e.g., as illustrated in FIGS. 4-7, defined settings from show “Everything” to “Emphasize Selection”) using a continuous function. In some implementations, continuous functions can be made up of multiple functions working together as a single continuous function. In some implementations, there can be multiple versions of each connection type; for example, a first version that is complete (fully visible) and a second version that is incomplete (has at least one end point outside of a visible area on a visual display).

In some implementations, a “union” from several (possibly many) source structures with a flat list of fields to a target structure containing several groups—each containing a flat list of fields is to be mapped (e.g., see FIG. 4 for an example). In some implementations, source structures can be displayed in a closed mode (e.g., a collapsed directory structure tree with just the top level directory name displayed with a title showing, but also informing a viewer about existing connections to the fields associated with the closed source structure. The groups of the target structure can similarly also be displayed in a closed mode, just showing the group title.

In some implementations, the following example CTs exist with an example defined graphical representation:
1) Basic Field-to-Field connection→Black, dashed, constantly thick
2) Closed Structure-to-Field or Closed Structure-to-Closed Group (“completed” mapping: every field of the target group is connected to a field of the source structure): Calculated information→Black, dashed, constantly thin
3) Field-to-Field (selected)→Black, constantly solid, constantly thick
4) Closed Structure-to-Field (selected):→Black, constantly solid, constantly thin
5) Closed Structure-to-Closed Group (“incomplete” mapping, at least one connection is there but some fields of the target group have not yet a connection to the corresponding source structure)→Black, wider dashed, constantly thin.
   As will be appreciated by those of ordinary skill in the art, the example connection types and/or defined graphical representation is only one possible implementation. This example is provided to enhance understanding of the described concepts and is not meant to be limiting in any way.

In one example, one version (e.g., a connection version (CV)) of connections exists for those that are fully visible (e.g., both connection endpoints are visible at the same time in a visual area of a visual display) and another version of connections exist where a connection endpoint is outside the visible area of the visual display. In one instance, the latter are rendered in the same way as the fully visible ones, only the displayed connection line width is reduced to half of the former connection line width.

In some implementations, two types of continuous functions are defined. First, for every CTi, define a “dimming” continuous function ƒᵢ(x) with the basic visual output values of a color, line style, etc. of a connection type defined by a range of defined settings (e.g., 0 to 3 or 1 to 4, etc.) of a GUI element. In some implementations, the values associated with each defined setting of the slider can be configured with values of a number between 0 and 100 for a “dimming” factor (e.g., in some implementations, “0” can mean not visible or “white” while “100” means black or other color; in other implementations, other values are also possible). This means that based on the position of the slider, more or less connection data can be displayed on a visual display to de-clutter a display, only show particular connections, etc. Here, a dimming factor can cause a connection to get lighter (e.g., fade) in relation to other connection types or to change line styles (e.g., a solid to coarse dashed line and to finely dotted line, etc.). For an implementation using color, it is assumed that colors are represented by 8-bit RGB values, but any suitable values can be used if consistent with this disclosure and are indeed considered to be within the scope of this disclosure. For example, a slider-setting-dependent color (for an implementation using color) of a connection type can be calculated as such:

For a connection type i and a slider position x₀ and an RGB-value (Rᵢ,Gᵢ,Bᵢ) as an original color of connection type i, then the actual color is:

((255−Rᵢ)*(100−ƒᵢ(x₀))/100+Rᵢ,

(255−Gᵢ)*(100−ƒᵢ(x₀))/100+Gᵢ,

(255−Bᵢ)*(100−ƒᵢ(x₀))/100+Bᵢ)

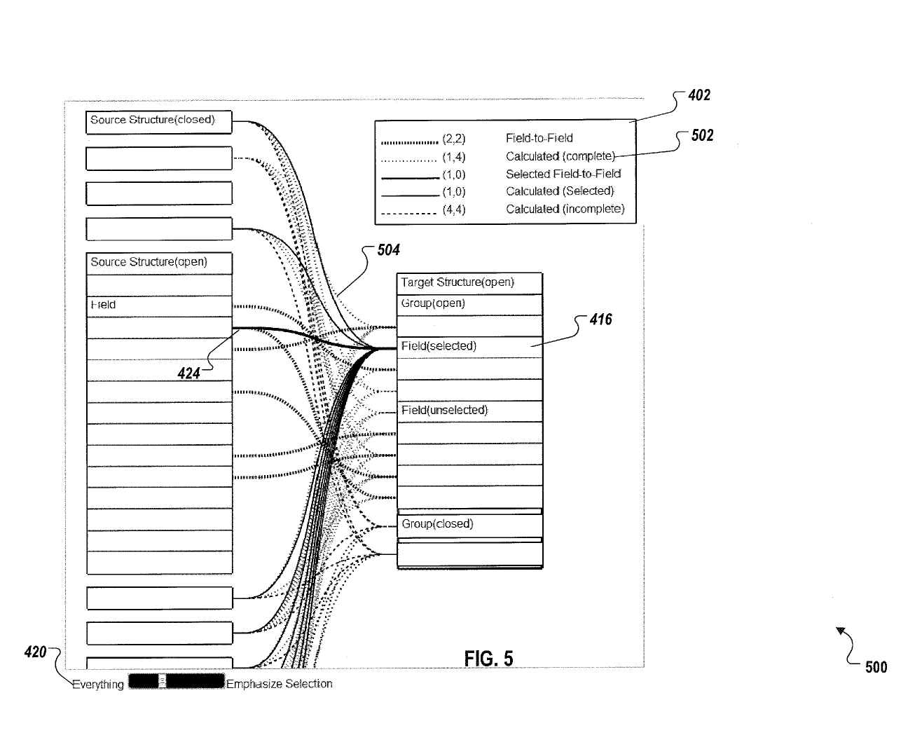

Second, for every connection type, another continuous function is defined to change a “Z-order” (i.e., overlapping behavior) of a first connection type in relation to other connection types at the defined settings of the same slider range as with the first continuous function type. For example, if a slider is moved one setting to the right toward “Emphasize Selection” from show “Everything” (see FIG. 5 for an example), the second continuous function can ensure that any overlapping connections on the visual display are properly visually displayed. The Z-order continuous function can ensure that a first connection type is “drawn” on a display only after a second connection type is drawn to ensure that the first connection type “overlays” the second connection type (i.e., is higher in a Z-axis order). This second continuous function is crucial to avoid undesirable obscurations in a graphical mapping. In some implementations, for the Z-order functions, constants are assumed, while in other implementations, The Z-order functions can be non-constant and continuous).

For an example with black and white connections, simulating “dimming” of connections without grey-scale is accomplished by defining three families of functions widthᵢ(x), dashᵢ(x), spaceᵢ(x) with the following semantics:

widthᵢ(x) describes the width of the connection.

dashᵢ(x) describes the length of the “dash-part” of a dashed connection

spaceᵢ(x) describes the length of the “space-part” of a dashed connection

Four equidistant discrete anchor points (slider defined settings) are defined on the range of the slider. For example (see FIGS. 4-7), in the leftmost position of the slider (at the “Everything” position), “everything” is visible with respect connections. When “sliding” the slider/dimmer to the right toward the rightmost position (at the “Emphasize Selection” position), less interesting aggregated connection info is “removed” from the visual area of the visual display (e.g., a second CT (CT2) as described above), but incomplete connections (e.g., a fifth CT (CT5) as described above) because additional mapping may need to be performed. Finally, in the rightmost position, a “selected” CT can be desired to be emphasized, but a lightweight representation of the second and fifth CTs (CT2 and CT5, respectively) should be seen in relation to the selected CT.

Further, two sets of five-tuple visual appearance values (one tuple value for each CV and CT for each anchor point for each function family). The continuous functions are then calculated as linear functions for each interval between two successive anchor points.

Although the slider is illustrated above with only four discrete, equidistant anchor points, in other implementations, there could be more or less anchor points with corresponding values for each connection type and/or version. For example, there could be “half” values defined between each above-described anchor point that can also change the visual display characteristics of a connection type/version. In other configurations, the slider can generate a range of possible values at a configurable granularity level. For example, the slider could be set with 50 anchor points where user manipulation of the slider could result in the appearance of a continuous range of values as opposed to distinct anchor points. In other implementations, the position of the slider can be determined based on a graphical/coordinate position on the user interface and a slider value calculated for use by the visual appearance function and/or the Z-order function.

In other implementations, the continuous functions can be dynamically adapted during runtime depending on context. For example, if elements of a graphical mapping on a visual display are scrolled so that connections classified as CT1 are changed to CT2, the continuous functions can be triggered to modify the visual appearance of the connections.

For example, for widthᵢ(x), the values (in this example constants) at the anchor points could be:
Fully visible connection:

| | |
|---|---|
| CV1CT1 | [4, 4, 4, 4] |
| CV1CT2 | [2, 2, 2, 2] |
| CV1CT3 | [4, 4, 4, 4] |
| CV1CT4 | [2, 2, 2, 2] |
| CV1CT5 | [2, 2, 2, 2] |

Partially visible—connection end point outside the visible area (here displayed at half width of fully visible connections):

| | |
|---|---|
| CV2CT1 | [2, 2, 2, 2] |
| CV2CT2 | [1, 1, 1, 1] |
| CV2CT3 | [2, 2, 2, 2] |
| CV2CT4 | [1, 1, 1, 1] |
| CV2CT5 | [1, 1, 1, 1] |

For the values at the anchor points for dashᵢ(x), the tuples are the same for CV1 (fully visible) and CV2 (partially visible) (hence the “CVX” designation):

| CVXCT1 | [2, 2, 1, 1] | |
|---|---|---|
| CVXCT2 | [2, 1, 1, 1] | |
| CVXCT3 | [1, 1, 1, 1] | // e.g., any non-zero number can be |
| here | | |
| CVXCT4 | [1, 1, 1, 1] | / e.g., any non-zero number can be |
| here | | |
| CVXCT5 | [4, 4, 4, 4] | // e.g., longer dashes |

Note that the value for spaceᵢ(x) below for CVXCT3 and CVXCT4 has a zero value (that is “no space” or “solid”). For the dashᵢ(x) function, any positive number would have no effect—the connection would render as “solid” (no dashing since space between dashes is set to 0). Alternatively, a zero value here for dashᵢ(x) with a zero value for spaceᵢ(x) would make the connection completely disappear (that is “no space” and “no dash”). For a positive space value and a positive dash value, a dash consistent with the values would be rendered.

For the values at the anchor points for spaceᵢ(x), the tuples are the same for CV1 (fully visible) and CV2 (partially visible):

| | | |
|---|---|---|
| CVXCT1 | [2, 2, 4, 6] | |
| CVXCT2 | [2, 4, 6, 8] | |
| CVXCT3 | [0, 0, 0, 0] | // e.g., no space = solid |
| CVXCT4 | [0, 0, 0, 0] | // e.g., no space = solid |
| CVXCT5 | [4, 4, 8, 12] | // e.g., wider spacing than CV1CT2 |

For the Z-Order functions, constants are assumed. For this example, the following values exist at the anchor points:

| | | |
|---|---|---|
| CVXCT1 | [2, 2, 2, 2] | |
| CVXCT2 | [4, 4, 4, 4] | |
| CVXCT3 | [0, 0, 0, 0] | // e.g., connection is “on top” |
| CVXCT4 | [1, 1, 1, 1] | |
| CVXCT5 | [3, 3, 3, 3] | |

For example, if it is desired to view a CT5 (“Closed Structure-to-Closed Group”) where connections of CT5 are:
“below” CT1 and CT2 for the left half range of the slider and
“above” CT1 and CT2 for the right half range of the slider, the following could be defined:

| | | |
|---|---|---|
| CVXCT1 | [2, 2, 3, 3] | |
| CVXCT2 | [3, 3, 4, 4] | |
| CVXCT3 | [0, 0, 0, 0] | // e.g., connection is “on top” |
| CVXCT4 | [1, 1, 1, 1] | |
| CVXCT5 | [4, 4, 2, 2] | |

Considerations with respect to Z-Order:
1) In typical implementations, the values of the table are used to build up the order of painting. The values themselves are not really meaningful exception in relation to each other. For example, the following table would produce the same behavior as the preceding example:

| | | |
|---|---|---|
| CVXCT1 | [4, 4, 8, 6] | |
| CVXCT2 | [6, 6, 10, 8] | |
| CVXCT3 | [0, 0, 0, 0] | // e.g., connection is “on top” |
| CVXCT4 | [1, 1, 1, 1] | |
| CVXCT5 | [7, 8, 4, 3]. | |

2) For some slider settings, we might have the same result value for several connection types. For example, assuming the table directly above, CVXCT1 and CVXCT5 can have a value of “6” if the slider is exactly in the middle position (e.g., half way between the values of the two middle slider positions—here either between 4 and 8 for CVXCT1 or between 8 and 4 for CVXCT5). For this case, a deterministic resolution policy of some type is needed. For example, in some implementations, “in case of equality, the CTX with the “lower” number is painted on the visual area of the visual display above the other.” Other deterministic resolution policy/ies consistent with this disclosure are also possible.
3) In some implementations, even if the functions used are continuous, a change of the Z-Order depending on the slider setting is a discrete, “non-continuous” event that might surprise the user.

In some implementations, it is possible to incorporate contextual information into the functions. For example, assume static functions ƒᵢ(x) defining a “dimming” value between 0 and 100 and not reflecting any context. In some implementations, another parameter can be added to the functions to reflect some context that results from the interaction of a user with the mapping, for example “(un)selecting a field” or “collapse/expand groups.” The parameter could adjust the functions whether there is a selection (or not) and/or what is the maximal depth of the expanded nodes.

In some instances, different functions can be described for each parameter value as long as the functions are related in an understandable way. For example, incorporating a BOOLEAN parameter whether there is a selection at all or not:

ƒᵢ(x, “nothing selected”)—, for the same example CTs described above, but where the values of CT3 and CT4 are not defined (because nothing is selected).

Fully Visible:

| | |
|---|---|
| CV1CT1 | [10, 100, 100, 100] |
| CV1CT2 | [0, 0, 50, 100] |
| CV1CT5 | [10, 100, 100, 100] |

ƒᵢ(x, “some target field selected”)—now applying a “dimfactor” of 0.5 on the above values of the “unselected types” (CT1, CT2, CT5)

Fully Visible:

| | | |
|---|---|---|
| CV1CT1 | [5, 50, 50, 50] | |
| CV1CT2 | [0, 0, 25, 50] | |
| CV1CT3 | [100, 100, 100, 100] | // Constant |
| CV1CT4 | [50, 50, 50, 50] | //Constant |
| CV1CT5 | [5, 50, 50, 50] | |

In some implementations, the “dimfactor” is a constant value (e.g., can be stored somewhere in the system) or a variable value that can be changed (e.g., by a user, administrator, algorithm, a GUI element (e.g., another slider . . . ). Note that the functions for the partially visible connections are adjusted accordingly.

Typically, functions are transmitted by the server 102 (e.g., the server application 107) to the client 140 (e.g., the client application 146 and/or graphical processor 147) to be processed and leveraged by the client to visually modify connections. Graphical processing typically takes place on the client. In some implementations, the server application 107 can perform graphical processing for connection visual display properties using the functions 122 in response to the manipulation of the user interface on the client and transmit update data to the client application 146 and/or graphical processor 147 to display to a user on the client 140.

The server application 107 is an algorithmic software engine capable of providing, among other things, any appropriate function consistent with this disclosure for the server 102. Typically, the server application 107 provides, among other things, functionality allowing a client 140 to perform network-type mapping of data (e.g., a modeling application) with many connections (e.g., a database, ERP model, etc.). In some implementations, the server application 107 can provide and/or modify content provided by and/or made available to other components of the EDCS 100. In other words, the server application 107 can act in conjunction with one or more other components of the server 102 and/or EDCS 100 in responding to a request for content received from the client 140.

Although illustrated as a single server application 107, the server application 107 may be implemented as multiple server applications 107. In addition, although illustrated as integral to the server 102, in alternative implementations, the server application 107 can be external to the server 102 and/or the EDCS 100 (e.g., wholly or partially executing on the client 140, other server 102 (not illustrated), etc.). Once a particular server application 107 is launched, the particular server application 107 can be used, for example by an application or other component of the EDCS 100 to interactively process received requests (e.g., from client 140). In some implementations, the server application 107 may be a network-based, web-based, and/or other suitable application consistent with this disclosure.

In some implementations, a particular server application 107 may operate in response to and in connection with at least one request received from other server applications 107, other components (e.g., software and/or hardware modules) associated with another server 102, and/or other components of the EDCS 100. In some implementations, the server application 107 can be accessed and executed in a cloud-based computing environment using the network 130. In some implementations, a portion of a particular server application 107 may be a web service associated with the server application 107 that is remotely called, while another portion of the server application 107 may be an interface object or agent bundled for processing by any suitable component of the EDCS 100. Moreover, any or all of a particular server application 107 may be a child or sub-module of another software module or application (not illustrated) without departing from the scope of this disclosure. Still further, portions of the particular server application 107 may be executed or accessed by a user working directly at the server 102, as well as remotely at a corresponding client 140. In some implementations, the server 102 or any suitable component of server 102 or the EDCS 100 can execute the server application 107.

The memory 108 typically stores objects and/or data associated with the purposes of the server 102 but may also be used in conjunction with the database 106 to store, transfer, manipulate, etc. objects and/or data. The memory 108 can also consistent with other memories within the EDCS 100 and be used to store data similar to that stored in the other memories of the EDCS 100 for purposes such as backup, caching, and/or other purposes.

The client 140 may be any computing device operable to connect to and/or communicate with at least the server 102. In general, the client 140 comprises an electronic computing device operable to receive, transmit, process, and store any appropriate data associated with the EDCS 100, for example, the server application 107. More particularly, among other things, the client 140 can collect and upload content to the server 102 for integration/processing into/by the server application 107. The client typically includes a processor 144, a client application 146, graphical processor 147, a memory/database 148, and/or an interface 149 interfacing over a system bus 141.

The client application 146 is any type of application that allows the client 140 to navigate to/from, request, view, create, edit, delete, administer, and/or manipulate content associated with the server 102 and/or the client 140. For example, the client application 146 can present GUI displays and associated data (e.g., models generated from mapping data 120, functions 122, etc.) to a user that are generated/transmitted by the server 102 (e.g., the server application 107 and/or database 106) to allow a user to perform modeling functionality for network-type mapping with many connections, accept user input, and transmit the user input back to the server 102 for dissemination to the appropriate components of server 102, in particular the server application 107 and/or the database 106. In some implementations, the client application 146 can use parameters, metadata, and other information received at launch to access a particular set of data from the server 102 and/or other components of the EDCS 100. Once a particular client application 146 is launched, a user may interactively process a task, event, or other information associated with the server 102 and/or other components of the EDCS 100. For example, the client application 146 can generate and transmit a particular database request to the server 102.

In some implementations, the client application 146 can also be used perform administrative functions related to the server application 107, database 106, and/or the server 102 in general. For example, the server application 107 can generate and/or transmit administrative pages to the client application 146 based on a particular user login, request, etc. to allow updating of mapping data 120, functions 122, and/or other data on the server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The graphical processor 147 is any type of application that allows the client 140 to model and/or vary a display of a network-type mapping with many connections. For example, the graphical processor 147 can be a separate application from the client application 146 or integrated wholly or partially with the client application 146. For example, graphical processor 147 could be a plug-in interfaced with the client application 146, a stand-along native application that registers with and/or receives a registration from the client application 146 to allow the client application 147 and graphical processor 147 to perform cooperative functionalities, or executable code served by server 102 (e.g., by the server application 102) that is executed on the client in the client application 146 and/or the graphical processor 147. In some implementations, the client application 146 and/or graphical processor 147 can transmit dimmer settings to the server application 107 which can perform graphical processing of a network-type mapping in response to the manipulation of the dimmer on the client 140 and receive processed data to be displayed on the client 140.

In some implementations, the graphical processor 147 can act as an interface between the server 102 and the client application 146 for some or all data transmitted to and/or from the server 102. In some implementations, the server application 107 and/or database 106 can perform some type of pre-processing before transmitting any data (e.g., mapping data 120, functions 122, etc.) to the client application 146 and/or graphical processor 147.

In some implementations, the graphical processor 147 can present GUI displays and associated data to a user as generated by the server application 107 and/or database 106 in order to allow a user to perform modeling functionality for network-type mapping with many connections, accept user input, and transmit data to the server 102 for dissemination to the appropriate components of server 102, in particular the server application 107 or database 106. In some implementations, the graphical processor 147 can use parameters, metadata, and other information received at launch to access a particular set of data from the server 102 and/or other components of the EDCS 100. Once a particular graphical processor 147 is launched, a user may interactively process a task, event, or other information associated with the server 102 and/or other components of the EDCS 100.

In some implementations, the graphical processor 147 can also be used perform administrative functions related to the server application 107, database 106, and/or the server 102 in general. For example, the server application 107 can generate and/or transmit administrative pages to the client application 146 based on a particular user login, request, etc. to allow updating of mapping data 120, functions 122, and/or other data on the server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The interface 149 is used by the client 140 for communicating with other computing systems in a distributed computing system environment, including within the EDCS 100, using network 130. For example, the client 140 uses the interface to communicate with a server 102 as well as other systems (not illustrated) that can be communicably coupled to the network 130. The interface 149 may be consistent with the above-described interface 104 of the server 102. The processor 144 may be consistent with the above-described processor 105 of the server 102. Specifically, the processor 144 executes instructions and manipulates data to perform the operations of the client 140, including the functionality required to send requests to the server 102 and to receive and process responses from the server 102.

The memory/database 148 typically stores objects and/or data associated with the purposes of the client 140 but may also be consistent with the above-described database 106 and/or memory 108 of the server 102 or other memories within the EDCS 100 and be used to store data similar to that stored in the other memories of the EDCS 100 for purposes such as backup, caching, and the like. Although illustrated as a combined memory/database, in some implementations, the memory and database can be separated (e.g., as in the server 102).

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the server 102, or any other component of the EDCS 100. In particular, in some implementations, the client application 146 may render GUI interfaces received from the server application 107, graphical processor 147, and/or data retrieved from any element of the EDCS 100.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

Although the following examples feature a GUI represented in black and white with variations in line thickness, dashing, etc., implementations of the describe subject matter are not limited to this particular example. For example, the described subject matter can be applied to user interfaces with connections of multiple colors, shading, etc. With these interfaces, for example, variations of the above-described slider can cause connections to lighten (e.g., fade) or darken, change color/intensity, etc. In some implementations, it is possible to have multiple sliders, each performing a different function. For example, one slider can have dimming functionality, another slider can vary line thicknesses, etc. It is also envisioned that each slider can change more than one single property simultaneously.

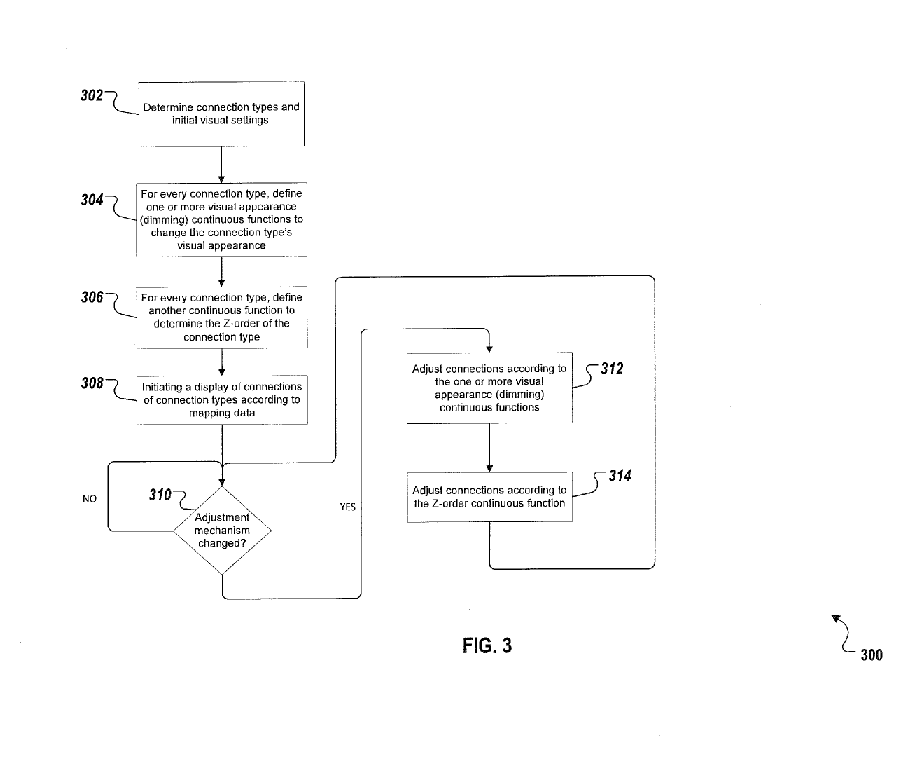

FIG. 3 is a flow chart illustrating a method 300 for providing improved lucidity in network mapping with many connections according to an implementation. For clarity of presentation, the description that follows generally describes method 300 in the context of FIGS. 1-2, and 4-7. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, and/or in any order.

At 302, connection types and initial visual settings are determined. For example, as described above for an implementation using color, the visual look of each type of connection (e.g., thick/thin, dashed, and dotted lines, RGB values, intensity, etc.) and default visual values for each connection type are established. For a black and white implementation, while RGB may only be applicable for black and white coloring, attributes for connection types such as line thickness, dashing, dotting, etc. can be established (including default values). Typically this data is stored in the mapping data described above. From 302, method 300 proceeds to 304.

At 304, for every connection type, one or more visual appearance (dimming) continuous functions (e.g., as described above—width, dash, space, etc.) are defined to change the connection type's visual appearance. From 304, method 300 proceeds to 306.

At 306, for every connection type, a Z-order continuous function (e.g., as described above) is defined to determine the Z-order of the connection type in relation to other connection types. From 306, method 300 proceeds to 308.

At 308, a display of connections of the connection types is initiated for a graphical network mapping according to the mapping data. For example, a user access the server application to view the graphical network mapping, the server application accesses the mapping data and functions from the database 106 and transmits data to the client application and/or graphical processor on the client to be processed and displayed. With the graphical network map, one or more graphical adjustment mechanisms are displayed for a user to interact with. In some implementations, the first display of the connections is according to a default configuration defined by the mapping data.

Turning to FIG. 4, FIG. 4 is an example screenshot 400 of a graphical network mapping displaying everything according to an implementation. In this example, initial visual settings are default settings associated with displaying everything and when the graphical network mapping is displayed, the above-described graphical adjustment mechanism(s) are set to a setting of “Everything.” In other implementations, the default can be set to any value of the above-described graphical adjustment mechanism(s).

Legend 402 provides a key to displayed connection types showing an exemplary line for CT for the current slider/dimmer value. For example, the number pair in parenthesis shows current lengths of “dash” and “space” for dashed connections (width remains constant as configured above—but could also reflect changing values in other implementations). As a more concrete example, referring to 422 in FIG. 4, “(1,0)” means (“solid”, “no space”).

The graphical network mapping contains various graphical interface elements. For example, a field 404, a source structure (closed) 406, a source structure (open) 408, a group (open) 410, a group (closed) 412, etc. In the target structure (open) 414, a field (selected) 416 and a field (unselected) 418 are also illustrated. Elements marked (open) indicate that they contain other elements. For example, source structure (open) 408 could in some implementations be “collapsed” and contain field 404 (and other adjacent elements below it). Source structure (closed) 406 illustrates what source structure (open) 408 would resemble if closed. Group (open) 410 is another hierarchical element used to group fields, groups, etc. For example, in some implementations, group (open) 410 contains field (selected) 416 and field (unselected) 418.

Graphical adjustment mechanism (slider) 420 is set to the far left setting (“Everything”) meaning that all connections are displayed with their default visual settings. For example, each connection type illustrated in connection legend 402 is displayed as in the legend. As a particular example, a “Selected Field-to-Field” connection type 422 in connection legend 402 is displayed as connection 424 (note the heavy solid black line). Similarly, connection types “Calculated Selected)” 426 and “Calculated (incomplete)” 430 are displayed as connections 428 (note the finer solid black line) and 432 (note the dotted line). Note also that connection types “Calculated Selected)” 426 and “Calculated (incomplete)” 430 can be considered partially visible (e.g., connection endpoint is outside the visual area as described above). Note that, in this example, only CT1 (“Field-to-Field”) and CT3 (“Selected Field-to-Field”) are actual connections. CT2, CT4, and CT5 are “calculated” connections indicating something about actual connections hidden by collapsed groups. The differentiation between CT2 and CT5 should provide some hint for a user for next steps to perform. For example, CT2 reveals that every currently collapsed field is mapped, while CT5 reveals that at least one currently collapsed field is lacking at least one mapping (this might motivate a user to open the associated group to fix a potential bug). Returning to FIG. 3, from 308, method 300 proceeds to 310.

At 310, a determination of whether the adjustment mechanism configuration (e.g., setting, position, etc.) has been changed is performed. If the graphical adjustment mechanism has not been changed, method 300 proceeds back to 310. If the graphical adjustment mechanism has been changed, method 300 proceeds to 312.

At 312, connections are adjusted according to the one or more visual appearance (dimming) continuous functions. Turning now to FIG. 5, FIG. 5 is an example screenshot 500 of a graphical network mapping adjusted to display certain types of connections less-prominently. Consistent with the explanation above with respect to FIG. 1 and regarding dimming continuous function tuple values, the width of “Selected Field-to-Field” connection type 422 in connection legend 402, connection 424 has not been altered based on the adjustment of the slider 420 as the width values remain constant (e.g., CV1CT3 [4,4,4,4]//Constant) regardless of the slider position (the same is also true for the dash and space functions). However, the dash and space function values changed for CT2 “Calculated (complete)” 502 (at least, e.g., connection 504) has been “dimmed” by the adjustment of the slider 420 toward “Emphasize Selection” (i.e., dash and space values changed from “(2,2)” to “(1,4),” respectively) as compared to the same connection type in FIG. 4. Note that CT2 has changed its dotted line configuration due to the defined tuple value for this slider 420 setting. From 312, method 300 proceeds to 314.

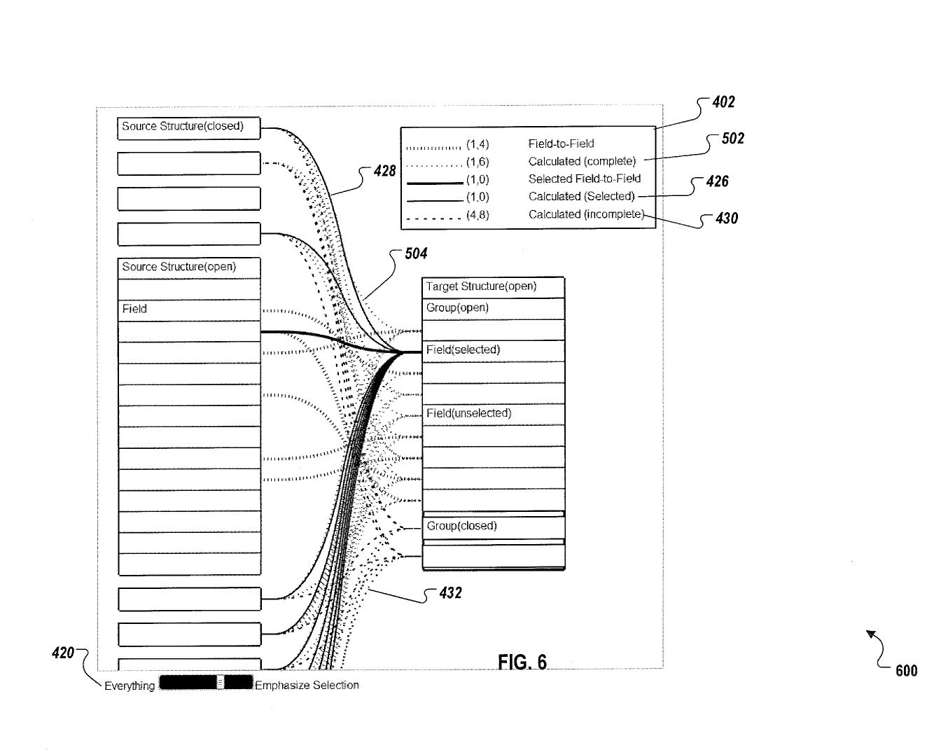

Turning now to FIG. 6, FIG. 6 is an example screenshot 600 of a graphical network mapping further adjusted to display certain types of connections less-prominently according to an implementation. As an example, in contrast to FIG. 5, the connection type “Calculated (complete)” 502 (at least, e.g., connection 504) has been “dimmed” again by the adjustment of the slider 420 toward “Emphasize Selection” (i.e., dash value changed from “4” to “6”)). As compared to the same connection type in FIG. 4, connection type “Calculated (complete)” 502 (e.g., connection 504) has again changed its dotted line configuration due to the defined space tuple value for this slider 420 setting.

Connection type “Calculated Selected” 426 and “Calculated (incomplete)” 430 are also displayed as connections 428 (note the unchanged finer solid black line—due to defined constant width, dash, and space values) and 432 (note the further dimmed dotted line—due to a space value changing from “4” in FIG. 5 to “8” in FIG. 6). Returning to FIG. 3, from 308, method 300 proceeds to 310.

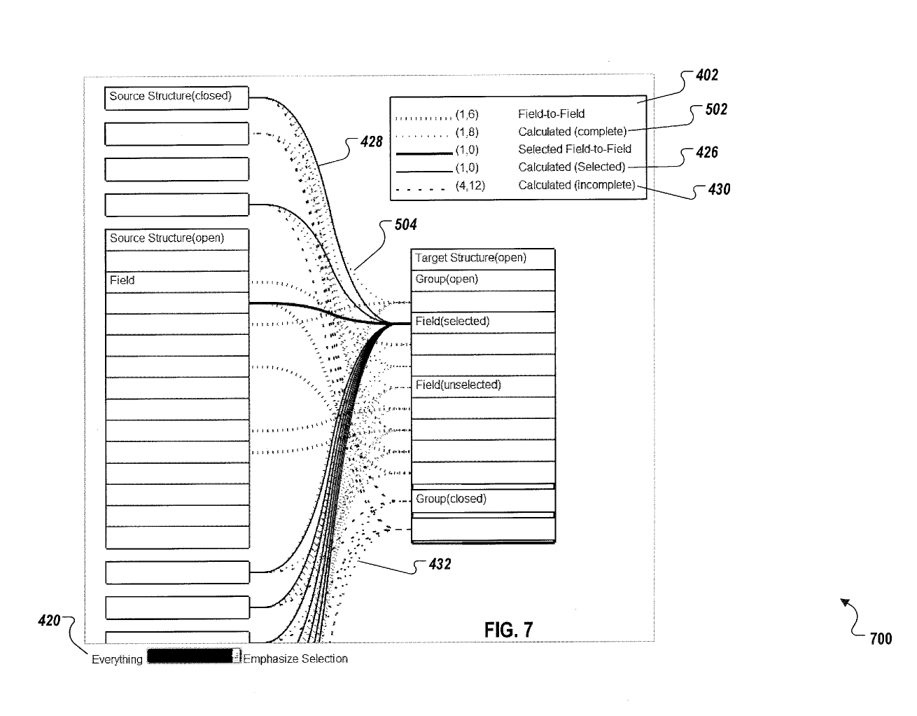

Turning now to FIG. 7, FIG. 7 is an example screenshot 700 of a graphical network mapping set to display a focus on selected mappings according to an implementation. As an example, in contrast to FIG. 6, the connection type “Calculated (complete)” 502 (at least, e.g., connection 504) has again been “dimmed” by the adjustment of the slider 420 to “Emphasize Selection” (i.e., space value changed from “6” in FIG. 6 to “8” in FIG. 7). Connection type “Calculated Selected” 426 and “Calculated (incomplete)” 430 are also displayed as connections 428 (note the unchanged finer solid black line—due to defined constant width, dash, and space values)) and 432 (note the further dimmed dotted line—due to a space value changing from “8” in FIG. 6 to “12” in FIG. 7). It should be apparent in FIG. 7, as compared to FIGS. 4-6, that connections appear less prominent as the slider 420 is moved from “Everything” toward “Emphasize Selection.”

At 314, connections are adjusted according to the Z-order continuous function. From 314, method 300 proceeds back to 310.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
determining a connection type and initial visual settings for a connection associated with a graphical mapping;
for the connection type:
define one or more visual appearance functions to change the connection's visual appearance based upon the configuration of an adjustment mechanism; and
define a Z-order function to determine the Z-order of the connection type in relation to other connection types;
determining that the adjustment mechanism configuration has been changed; and
adjusting the connection, by operation of a computer, according to a value of the one or more visual appearance functions based on a value of the adjustment mechanism configuration.

2. The method of claim 1, wherein the connection type can be one of a fully visible connection type where the endpoints of a connection are displayed on the same visual display or a partially visible connection type where one of the endpoints of a connection is not displayed on the same visual display as the other endpoint of the connection.

3. The method of claim 1, wherein the one or more visual appearance functions and the Z-order function are continuous functions.

4. The method of claim 1, wherein the one or more visual appearance functions include functions for width, dash, and space.

5. The method of claim 1, wherein data associated with the connection type used by the one or more visual appearance functions comprises a tuple of visual appearance values, each visual appearance value associated with each configuration value of the adjustment mechanism.

6. The method of claim 1, wherein the adjustment mechanism is a graphical user interface element with a discrete number of anchor points, each anchor point representing a configuration value of the adjustment mechanism.

7. The method of claim 1, comprising adjusting, by operation of a computer, the Z-order of the connection of the connection type using the Z-order function.

8. A non-transitory, computer-readable medium storing computer-readable instructions executable by a computer and configured to:
determine a connection type and initial visual settings for a connection associated with a graphical mapping;
for the connection type:
define one or more visual appearance functions to change the connection's visual appearance based upon the configuration of an adjustment mechanism; and
define a Z-order function to determine the Z-order of the connection type in relation to other connection types;
determine that the adjustment mechanism configuration has been changed; and
adjust the connection, by operation of a computer, according to a value of the one or more visual appearance functions based on a value of the adjustment mechanism configuration.

9. The medium of claim 8, wherein the connection type can be one of a fully visible connection type where the endpoints of a connection are displayed on the same visual display or a partially visible connection type where one of the endpoints of a connection is not displayed on the same visual display as the other endpoint of the connection.

10. The medium of claim 8, wherein the one or more visual appearance functions and the Z-order function are continuous functions.

11. The medium of claim 8, wherein the one or more visual appearance functions include functions for width, dash, and space.

12. The medium of claim 8, wherein data associated with the connection type used by the one or more visual appearance functions comprises a tuple of visual appearance values, each visual appearance value associated with each configuration value of the adjustment mechanism.

13. The medium of claim 8, wherein the adjustment mechanism is a graphical user interface element with a discrete number of anchor points, each anchor point representing a configuration value of the adjustment mechanism.

14. The medium of claim 8, comprising instructions to adjust the Z-order of the connection of the connection type using the Z-order function.

15. A system, comprising:
a memory;
at least one hardware processor interoperably coupled with the memory and configured to:
determine a connection type and initial visual settings for a connection associated with a graphical mapping;
for the connection type:
define one or more visual appearance functions to change the connection's visual appearance based upon the configuration of an adjustment mechanism; and
define a Z-order function to determine the Z-order of the connection type in relation to other connection types;
determine that the adjustment mechanism configuration has been changed; and
adjust the connection, by operation of a computer, according to a value of the one or more visual appearance functions based on a value of the adjustment mechanism configuration.

16. The system of claim 15, wherein the connection type can be one of a fully visible connection type where the endpoints of a connection are displayed on the same visual display or a partially visible connection type where one of the endpoints of a connection is not displayed on the same visual display as the other endpoint of the connection.

17. The system of claim 15, wherein the one or more visual appearance functions and the Z-order function are continuous functions and the one or more visual appearance functions include functions for width, dash, and space.

18. The system of claim 15, wherein data associated with the connection type used by the one or more visual appearance functions comprises a tuple of visual appearance values, each visual appearance value associated with each configuration value of the adjustment mechanism.

19. The system of claim 15, wherein the adjustment mechanism is a graphical user interface element with a discrete number of anchor points, each anchor point representing a configuration value of the adjustment mechanism.

20. The system of claim 15, configured to adjust the Z-order of the connection of the connection type using the Z-order function.
